(19) United States
(12) Patent Application Publication
(10) Pub. No.: US 2021/0406089 A1
(43) Pub. Date: Dec. 30, 2021

(54) Determination of Cloud Resource Utilization

(71) Applicant: CITRIX SYSTEMS, INC., Burlington, MA (US)

(72) Inventors: Steven Keller, Coral Springs, FL (US); Sindy Giraldo, Fort Lauderdale, FL (US)

(21) Appl. No.: 16/915,178

(22) Filed: Jun. 29, 2020

(51) Int. Cl. G06F 9/50; G06F 9/54; G06F 9/455

(52) U.S. Cl. CPC G06F 9/5077; G06F 2009/45595; G06F 9/45558; G06F 9/547

(57) ABSTRACT

Data characterizing a log of requests by a plurality of software services executing based on a virtual resource that is within a remote computing environment is received. The executing includes transmitting the requests for utilization of the virtual resource. A metric of utilization of the virtual resource by a first software service of the plurality of software services is determined based on the log. The metric of utilization characterizes a portion of total usage of the virtual resource that is attributable to the first software service. The metric of utilization is provided. Related apparatus, systems, techniques and articles are also described.

### TECHNICAL FIELD

The subject matter described herein relates to determining the utilization of cloud resources.

### BACKGROUND

Cloud computing can include the on-demand availability of computer system resources, especially data storage and computing power, without direct active management by the user. The term can be generally used to describe data centers available to many users over the Internet. Large clouds often have functions distributed over multiple locations from central servers.

Some cloud computing providers can allow for scalability and elasticity via dynamic (e.g., “on-demand”) provisioning of resources on a fine-grained, self-service basis. This can provide cloud computing users the ability to scale up when the usage need increases or down if resources are not being used.

### SUMMARY

In an aspect, data characterizing a log of requests by a plurality of software services executing based on a virtual resource that is within a remote computing environment is received. The executing includes transmitting the requests for utilization of the virtual resource. A metric of utilization of the virtual resource by a first software service of the plurality of software services is determined based on the log. The metric of utilization characterizes a portion of total usage of the virtual resource that is attributable to the first software service. The metric of utilization is provided.

One or more of the following features can be included in any feasible combination. For example, the metric of utilization can be a percent of resource utilized the first software service. The metric of utilization can be a percent determined based on a number of request by respective software services, an amount of time the virtual resource is utilized by the respective software services, geographic region of the respective software services, and/or a type of application programming interface calls to the virtual resource made by the respective software services.

Data characterizing a cost of the virtual resource can be accessed from the remote computing environment. A portion of the cost of the virtual resource attributable to the first software service can be determined based on the utilization metric and the cost of the virtual resource. Respective portions of the cost of the virtual resource attributable to respective software services of the plurality of software services can be determined for the plurality of software services and based on the utilization metric. A cost of the virtual resource attributable to a product, a feature of the product, and/or a service of the product can be determined based on the utilization metric.

The data characterizing the log can include a service name, a uniform resource identifier, a name of a consumer of a service, and a duration of use. The providing can include modifying usage of the virtual resource by at least one of the plurality of software services. The requests can include application programming interface calls to the remote computing environment. The virtual resource can include a virtual machine, a storage account, a web application, a database, and/or a virtual network. The first software service can include executable code deployed in the remote computing environment. The first software service can be a microservice.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A is a process flow diagram illustrating an example process for determining virtual resource utilization;

FIG. 1B illustrates an example data flow diagram illustrating the data flow between system components during the process illustrated in FIG. 1A;

FIG. 2 shows a high-level architecture of an illustrative virtualization system;

FIG. 3A depicts a network diagram illustrating an example of a network environment;

FIG. 3B depicts a block diagram illustrating an example of a computing device;

FIG. 4 is a process flow diagram illustrating another example process that can enable determination of virtual resource utilization; and

FIG. 5 is another process flow diagram illustrating an example process according to some implementation.

Like reference symbols in the various drawings indicate like elements.

### DETAILED DESCRIPTION

Cloud providers can provide a remote computing environment, for example, with virtual machine (VM) infrastructure such as a hypervisor using native execution to share and manage hardware, allowing for multiple environments which are isolated from one another, yet exist on the same physical machine. The computing environment can include an infrastructure as a service (IaaS) platform that provides application programming interfaces (APIs) to dereference low-level details of underlying network infrastructure. In such an IaaS platform, pools of hypervisors can support large numbers of VMs and include the ability to scale up and down services to meet varying needs. IaaS platforms can provide the capability to the user to provision processing, storage, networks, and other fundamental computing resources where the user is able to deploy and run arbitrary software, which can include operating systems and applications. The user may not manage or control the underlying cloud infrastructure but has control over operating systems, storage, and deployed applications; and possibly limited control of select networking components (e.g., host firewalls).

Companies with multiple software product offerings may utilize cloud computing resources for supporting those products. For example, a company may have many products being used by many business customers and millions of end users. Each product can include multiple services and each service can consume some amount of cloud resources as it executes (e.g., operates).

But when utilizing cloud computing to support multiple products, it may not be clear which virtual resources are associated with or support each product and how much of a given virtual resource is utilized by each product. This is because the products are supported by the same cloud service provider and there may be no clear way to track usage of the virtual resource by different software services that form the products.

For example, multiple software products forming a complex enterprise software system may utilize a database being hosted in the cloud. The database can, for example, support authentication activities for all the products within the complex enterprise software system. This can make it challenging to attribute usage and costs of the cloud virtual resource to a given product, thereby making it difficult to efficiently manage those products.

Accordingly, some implementations of the current subject matter include determining utilization of a virtual resource that includes logging all transactions (e.g., API calls) by software services and/or microservices to the cloud that hosts the virtual resources, then assessing the logs to determine utilization of those virtual resources contained within the cloud.

By logging transactions and then determining utilization based on the logs, an accurate determination of usage can be achieved. Moreover, different metrics of utilization can be implemented, for example, number of calls to a resource, amount of compute time utilized, amount of resource utilized by geographic region, and the like. And by understanding usage of virtual resources, a portion of the cost of the virtual resource can be attributed to a given software service, which can enable accurate understanding of the costs of a microservice, service, or product, thereby enabling more efficient management of software systems, such as complex enterprise software systems.

In some implementations, cloud resources can be tracked per microservice, which can be tracked by services, and services can be tracked by product. Products can be considered to include multiple services, for example, an aggregation of services to create an experience for a customers. A product can respond to an order for a customer and can provision a set of services, if applicable. Example products can include virtual applications and virtual desktops. A product can have a one to one relationship with a stock-keeping unit (SKU), thus reflecting an available product for purchase by customers.

A service can be considered as a set of microservices that manifests as a feature or product. A set of one or more services can make a product. An example service can include a StoreFront Configuration. In some implementations, multiple products may utilize at least some of the same services (e.g., a service may belong to multiple products). A service can be considered a logical representation of a feature of the product. A service or feature can also be provided separately (e.g., as an “add-on” to a product).

A microservice can be considered as a set of code deployed to the cloud with the scoping of specific jobs to functions to service a specific purpose. Example microservices include a “StoreFront Configuration—WebRole” and a “StoreFront Configuration—WorkerRole”. In some implementations, multiple services and products may utilize at least some of the same microservices (e.g., a microservices may belong to multiple services and multiple products).

As described herein, a resource (also referred to as a virtual resource or a cloud resource) can include any manageable item that is available through a cloud provider such as virtual machines, storage accounts, web applications, databases, and virtual networks. Other resource types are possible.

When running a business, it can be important to be able to track the Cost Of Goods Sold (COGS). This can be fairly straight forward with manufacturing businesses; however, with cloud service businesses that can consume many cloud resources and can be formed of many micro-services, it can be difficult to determine the COGS.

Some implementations of the current subject matter can include determining the percentage of resources being consumed by a particular micro-service (or feature). This can enable a mechanism by which the consumers of the resources can be identified and charged accordingly.

For an enterprise business it can be important to establish a chargeback model so that the true cost of the particular micro-service is known. If the true cost of a particular micro-service is not known, it is likely that correct pricing of a micro-service or feature will be incorrect. Knowing the true cost, however, will enable a more accurate pricing model of a micro-service or feature and allow the company to make an informed decision whether to increase/decrease a service's price or discontinue a service.

Some implementations of the current subject matter include a mechanism by which a chargeback percentage can be determined for each consumer of a particular micro-service. Given the chargeback percentage and the cloud resource cost, the COGS can then be determined at the micro-service level. Once this information is available at the micro-service level, it can be rolled up to the product or offering level as needed.

Some implementations of the current subject matter can be implemented where there is a logging layer that logs system transactions. For example, all products can require service registration and all system transactions can be logged. The logs can include service addresses (e.g., Internet Protocol (IP) addresses) and cloud resource addresses identifying the cloud resources involved in the system transaction. For example, a system can require that all services register a service key in order to consume (e.g., utilize) services within the system. This information can be leveraged in the logging to identify the IP address of the service making the call. In addition, the log can also include the resource IP address that is being called by the service. In some implementations, services can utilize virtual resources via application programming interface (API) calls and a log can be created related to each API call. The following is an example log message.

TABLE 1
EventTime = 2020-02-27T12:23:48
Level = INFO
LoggingType = Performance
DeploymentId = 954ac784204a4a068c07d32c97372d53
RoleId = AgentHub_IN_1
ServiceName = AgentHub
Version = 7.1.2.33125
LayerName = StagingA
RegionName = EastUS
BuildCommit = 9026e2449033e86f669bd8ff92700368bcaa3341
BuildNumber = 34622
CorrelationId = b9fd8c44-f0a4-46b4-830a-45a51691193c
CustomerId = g8a4thnldlnb
TransactionId = 210676e6-2304-4461-a38b-9707aac0f1aa
RequestMethod = GET
AbsoluteUri = https://agenthub-eastus-release-
a.ctxwsstgapi.net/g8a4thnldlnb/EdgeServers/3e4d2106-7fcb-482b-846e-0da3f2ea2e99
RefererHeader=
UserAgent=
CallerServiceName = EdgeService
CallerServiceInstanceId = 3e4d2106-7fcb-482b-846e-0da3f2ea2e99
SourceIP = ::ffff:207.47.50.254
EventId = ApiPerformance
DestinationIP = ::rrse:765.23.30.678
SourceCode = ApiPerformance.OnActionExecutedAsync@79
Message = {“Service”:“AgentHub”,“Controller”:“EdgeServers”,“Endpoint”:“Get”,“Uri”:
“https://agenthub-eastus-release-
a.ctxwsstgapi.net/g8a4thnldlnb/EdgeServers/3e4d2106-7fcb-482b-846e-
0da3f2ea2e99”,“CanaryRequestedUri”:“https://agenthub-
us.ctxwsstgapi.net/g8a4thnldlnb/EdgeServers/3e4d2106-7fcb-482b-846e-
0da3f2ea2e99”,“IsGlobalRequest”:false,“IsGloballyAware”:false,“Method”:“Get”,“St
artDateTime”:“2020-02-25T21:23:47.9654297Z”,“EndDateTime”:“2020-02-
25T21:23:48.1023632Z”,“Duration”:136.9752,“StatusCode”:“OK”,“Error”:null}

From the log entry shown above, the Service name being called is a microservice named AgentHub, the location of the microservice is eastus, the endpoint is edgeservers, the consumer of the microservice is EdgeService, and the duration of the call is 136.9752. This information enables generation of statistics on the usage of the AgenHub microservice, for example, the information from multiple logs can be aggregated to determine statistics on location, endpoints, consumers, duration of calls, and the like. The log can also enable a mapping of microservices and cloud resources, and it can provide business data that a cloud resource lacks. For example, the name of the microservice can be a business metric useful to track costs.

In some implementations, the AbsoluteUri field can be used to determine the specific function being accessed within the service, which can be used to narrow the focus area within the service. The Transactionld field can be used to group together multiple requests that belong to one higher level request. For example, accessing data on a customer premise may require requests to Authenticate, Authorize, Send a Message, Check feature enablement, and the like.

The CustomerId field can be used to determine resources that a particular customer is calling (e.g., APIs can be run on behalf of a customer based on an authentication service). The RegionName field can be used to determine resources being called in a particular region. This can be useful, for example, for a state of emergency, (e.g. hurricane, fire, tsunomi, and the like) or to ensure adequate resources available from the cloud resource provider because the cloud provider may only have so many resources in a given region. The Message field can be used to determine the time and duration of the specific call. The Message field can be related to overall resource consumption and can be correlated with any system issues (e.g. provider outages, security incidents, and the like)

Some implementations can provide for a flexible utilization metric. For example, one approach to determining utilization of a resource by a software microservice is to divide total utilization of the virtual resource by the number of consumers (e.g., the number of software microservices that utilized the resource) to determine a percent utilization. In such an approach, large consumers are apportioned the same as small consumers. Some implementation can count the number of calls made by each consumer and take the percentage of total calls as the utilization metric. As another example, the utilization metric can be determined by dividing the consumption of the given microservice by region (e.g., costs may be different based on region location) in addition to the count of calls made by each consumer. As yet another example, the utilization metric can factor in the duration of a request since a longer running operation is more likely to consume more resources. As yet another example, the utilization metric can be determined using the given API call types, since a type of API call may reflect an amount of utilization of the virtual resource. An example of different API call types can include a type of database operation (e.g., read or write). And in some implementations, all of the above approaches can be combined to take the operational time and look at all of the cloud spend during at the time the microservice was being called, to determine the overall utilization and apportion cost of a virtual resource to the consuming software microservices, services, products, and the like).

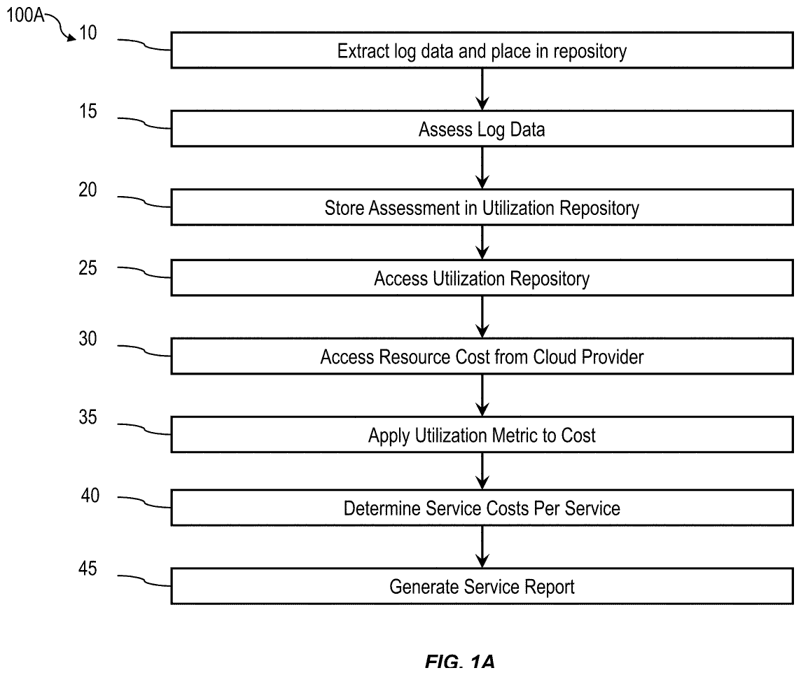

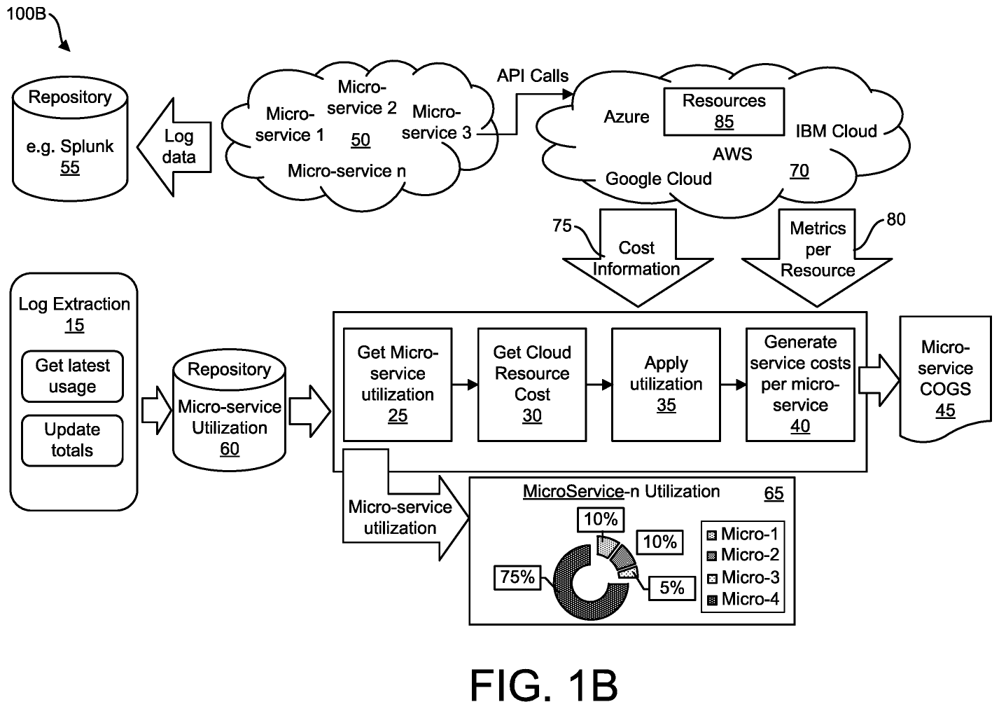

FIG. 1A is a process flow diagram illustrating an example process 100A for determining virtual resource utilization. Determining utilization of a virtual resource can include logging transactions (e.g., API calls) by software services to the cloud that hosts the virtual resources, then assessing the logs to determine utilization of those virtual resources contained within the cloud. By logging transactions and then determining utilization based on the logs, an accurate determination of usage can be achieved. FIG. 1B illustrates an example data flow diagram illustrating the data flow 100B between system components during the process 100A illustrated in FIG. 1A.

At 10, log data is regularly (e.g., periodically) extracted and placed in a raw statistics repository 55. In some implementations, the raw statistics repository 55 can include Splunk, although other implementations are possible. The log data can be generated by a logging layer that documents API calls of microservices 50 to virtual resources 85 of the cloud providers 70 (e.g., remote computing environments). Microservices 50 can form one or more software services, features, and/or products.

At 15, the log data is assessed. Assessment of the log data can include analyzing the log data based on time frame, service, and consumer. Cumulative statistics can be computed that characterize, for example, usage of a virtual resource by one or more of time frame, service, and consumer of the microservice. Per-service allocations of the virtual resource utilization can be determined, for example, as described above. At 20, the assessment of the log data can be stored in a utilization repository 60. The assessment of the log data can take the form of utilization by percentage, such as is illustrated at 65. In some implementations, the extraction, assessment, and saving of the assessment can be performed regularly (e.g., periodically) such that the assessment is updated based on recently created logs.

At 25, utilization repository is accessed and at 30, cloud resource costs are accessed from the cloud providers 70. The cloud resource costs can include cost information 75 of resources, and metrics per resource information 80, which can provide details on the virtual resources. Each resource type has an associated consumption metric. For example, a storage resource metric includes an amount of disk space; a database metric includes diskspace and utilization; and networking metrics can be based on ingress and egress. Cost information can be considered as some amount of cost per unit of measure. Determining how much a resource costs can include combining the cost per unit (e.g. cost information) with the number of units consumed. For example, Cost Per Unit×Number of Units=Cost of Resource. In addition to cost, data collected by the cloud resource can provide insights into utilization and performance. For example, a VM of a specific service can be utilized a low or high central processing unit (CPU) percentage or low or high memory utilization. In some implementations, resource cost 75 and metrics per resource information 80 is regularly (e.g., periodically) extracted from cloud providers 70.

At 35, the utilization metric can be applied to the resource cost 75. For example, a given resource cost can be multiplied by a percent utilization of the resource by a microservice to determine the portion of the resource cost that is attributable to the microservice. The utilization metric can be applied for all virtual resources.

At 40, costs per microservice can be determined. Determining costs per microservice can include determining, for each microservice 50, a total cost of the microservice by adding the portions of the resource costs that is attributable to that microservice. For example, a given microservice may utilize multiple resources. The respective portions of the resources utilized by the microservice can be combined to determine a total cost of goods for the microservice. Cost per service can be determined by combining the costs of the micro-services that are associated with the service. Cost per product can be determined by combining the costs of the services that are associated with the product. Where a micro-service or service is utilized by more than one service or product, respectively, then their associated costs can be considered proportionately, based on respective utilization.

At 45, a service cost of goods report can be generated. The service cost of goods report can include, for each microservice 50, a cost of the virtual resources that the microservice utilized. The service cost of goods report can also group microservices by service, services by product and/or features of a product. In some implementations, the service cost of goods report can include the utilization and consumption of individual APIs within the system.

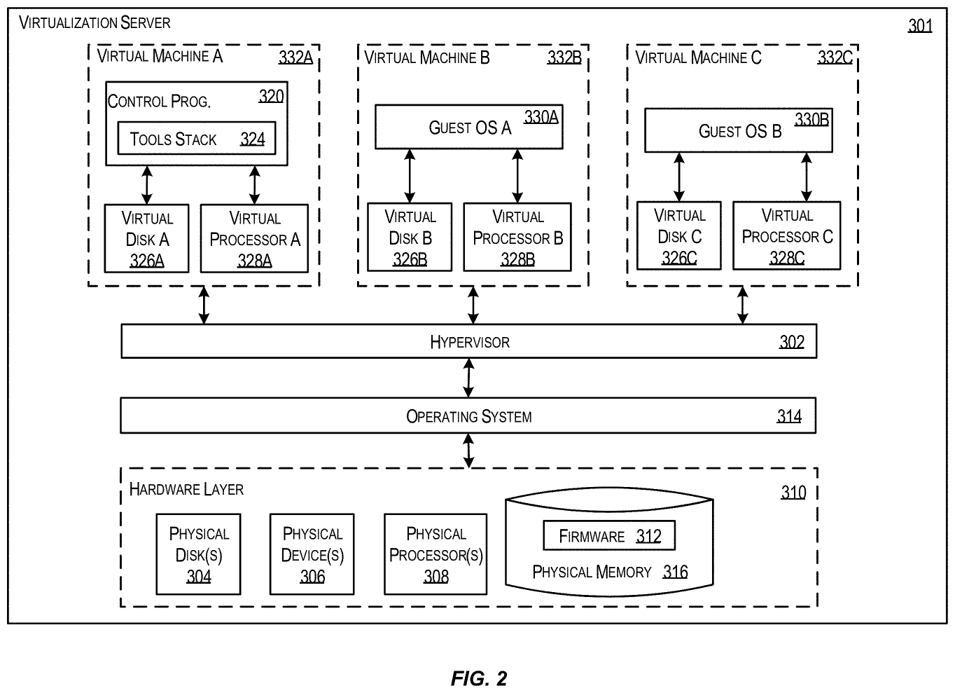

FIG. 2 shows a high-level architecture of an illustrative virtualization system that can enable determination of virtual resource utilization. Determining utilization of a virtual resource can include logging transactions (e.g., API calls) by software services to the cloud that hosts the virtual resources, then assessing the logs to determine utilization of those virtual resources contained within the cloud. By logging transactions and then determining utilization based on the logs, an accurate determination of usage can be achieved.

As shown, the virtualization system may be a single-server or multi-server system, or a cloud system, including at least one virtualization server 301 configured to provide virtual desktops and/or virtual applications to one or more client access devices 102a-c. As used herein, a desktop may refer to a graphical environment (e.g., a graphical user interface) or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per physical device) or virtual (e.g., many instances of an OS running on a single physical device). Each application may be executed on a local device, or executed on a remotely located device (e.g., remoted).

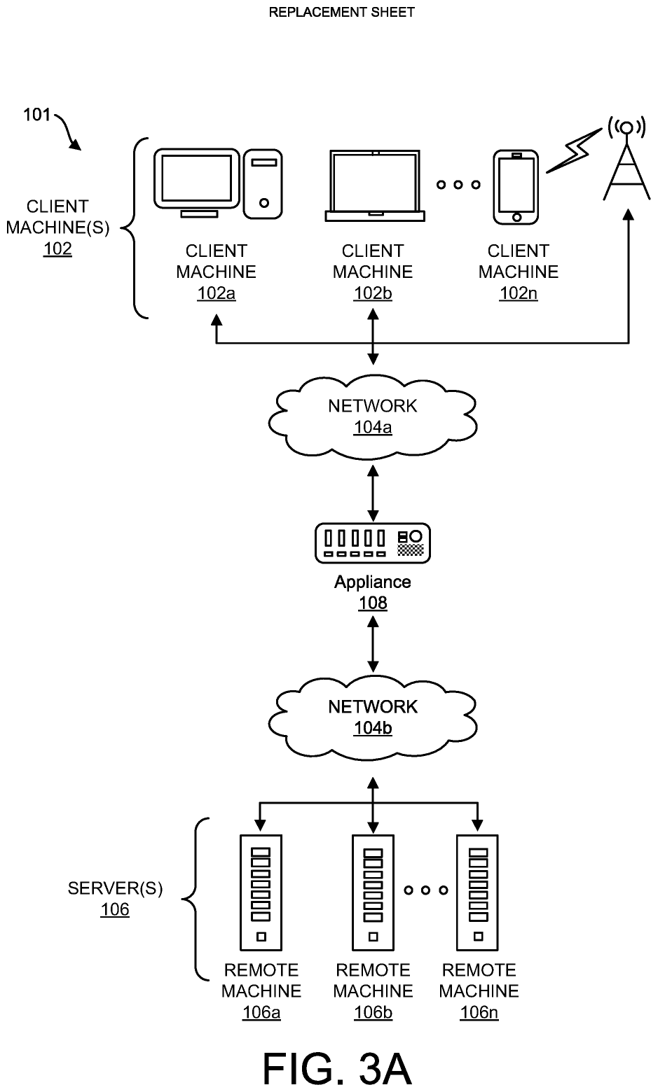

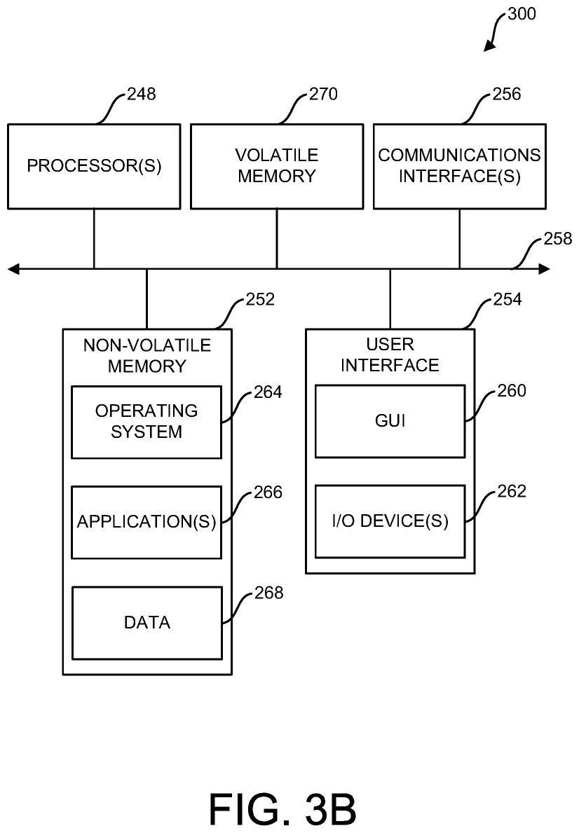

Virtualization server 301 may be configured as a virtualization server in a virtualization environment, for example, a single-server, multi-server, or cloud computing environment. Virtualization server 301 illustrated in FIG. 2 may be deployed as and/or implemented by one or more embodiments of server 106 illustrated in FIG. 3A or by other known computing devices. Included in virtualization server 301 is hardware layer 310 that may include one or more physical disks 304, one or more physical devices 306, one or more physical processors 308, and one or more physical memories 316. In some embodiments, firmware 312 may be stored within a memory element in physical memory 316 and be executed by one or more of physical processors 308. Virtualization server 301 may further include operating system 314 that may be stored in a memory element in physical memory 316 and executed by one or more of physical processors 308. Still further, hypervisor 302 may be stored in a memory element in physical memory 316 and be executed by one or more of physical processors 308. Presence of operating system 314 may be optional such as in a case where the hypervisor 302 is a Type A hypervisor.

Executing on one or more of physical processors 308 may be one or more virtual machines 332A-C (generally 332). Each virtual machine 332 may have virtual disk 326A-C and virtual processor 328A-C. In some embodiments, first virtual machine 332A may execute, using virtual processor 328A, control program 320 that includes tools stack 324. Control program 320 may be referred to as a control virtual machine, Domain 0, Dom0, or other virtual machine used for system administration and/or control. In some embodiments, one or more virtual machines 332B-C may execute, using virtual processor 328B-C, guest operating system 330A-B (generally 330).

Physical devices 306 may include, for example, a network interface card, a video card, an input device (e.g., a keyboard, a mouse, a scanner, etc.), an output device (e.g., a monitor, a display device, speakers, a printer, etc.), a storage device (e.g., an optical drive), a Universal Serial Bus (USB) connection, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in hardware layer 310 may include any type of memory. Physical memory 316 may store data, and in some embodiments may store one or more programs, or set of executable instructions. FIG. 2 illustrates an embodiment where firmware 312 is stored within physical memory 316 of virtualization server 301. Programs or executable instructions stored in physical memory 316 may be executed by the one or more processors 308 of virtualization server 301.

Virtualization server 301 may also include hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 may be any combination of executable instructions and hardware that monitors virtual machines 332 executing on a computing machine. Hypervisor 302 may be a Type 2 hypervisor, where the hypervisor executes within operating system 314 executing on virtualization server 301. Virtual machines may then execute at a layer above hypervisor 302. In some embodiments, the Type 2 hypervisor may execute within the context of a user's operating system such that the Type 2 hypervisor interacts with the user's operating system. In other embodiments, one or more virtualization servers 301 in a virtualization environment may instead include a Type 1 hypervisor (not shown). A Type 1 hypervisor may execute on virtualization server 301 by directly accessing the hardware and resources within hardware layer 310. That is, while Type 2 hypervisor 302 accesses system resources through host operating system 314, as shown, a Type 1 hypervisor may directly access all system resources without host operating system 314. A Type 1 hypervisor may execute directly on one or more physical processors 308 of virtualization server 301, and may include program data stored in physical memory 316.

Hypervisor 302, in some embodiments, may provide virtual resources to guest operating systems 330 or control programs 320 executing on virtual machines 332 in any manner that simulates operating systems 330 or control programs 320 having direct access to system resources. System resources can include, but are not limited to, physical devices 306, physical disks 304, physical processors 308, physical memory 316, and any other component included in hardware layer 310 of virtualization server 301. Hypervisor 302 may be used to emulate virtual hardware, partition physical hardware, virtualize physical hardware, and/or execute virtual machines that provide access to computing environments. In still other embodiments, hypervisor 302 may control processor scheduling and memory partitioning for virtual machine 332 executing on virtualization server 301. Examples of hypervisor 302 may include those manufactured by VMWare, Inc., of Palo Alto, Calif.; Xen Project® hypervisor, an open source product whose development is overseen by the open source XenProject.org community; Hyper-V®, Virtual Server®, and Virtual PC® hypervisors provided by Microsoft Corporation of Redmond, Wash.; or others. The virtualization server 301 may execute hypervisor 302 that creates a virtual machine platform on which guest operating systems 330 may execute. When this is the case, virtualization server 301 may be referred to as a host server. An example of such a virtualization server is Citrix Hypervisor® provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create virtual machine 332. The virtual machine image may refer to a collection of data, states, instructions, etc. that make up an instance of a virtual machine. In other embodiments, hypervisor 302 may execute guest operating system 330 within virtual machine 332. In still other embodiments, virtual machine 332 may execute guest operating system 330.

In addition to creating virtual machines 332, hypervisor 302 may control the execution of at least one virtual machine 332. The hypervisor 302 may present at least one virtual machine 332 with an abstraction of at least one hardware resource provided by virtualization server 301 (e.g., any hardware resource available within hardware layer 310). In some implementations, hypervisor 302 may control the manner in which virtual machines 332 access physical processors 308 available in virtualization server 301. Controlling access to physical processors 308 may include determining whether virtual machine 332 should have access to processor 308, and how physical processor capabilities are presented to virtual machine 332.

As shown in FIG. 2, the virtualization server 301 may host or execute one or more virtual machines 332. Virtual machine 332 may be a set of executable instructions and/or user data that, when executed by processor 308, may imitate the operation of a physical computer such that virtual machine 332 can execute programs and processes much like a physical computing device. While FIG. 2 illustrates an embodiment where virtualization server 301 hosts three virtual machines 332, in other embodiments virtualization server 301 may host any number of virtual machines 332. Hypervisor 302 may provide each virtual machine 332 with a unique virtual view of the physical hardware, including memory 316, processor 308, and other system resources 304, 306 available to that virtual machine 332. The unique virtual view may be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor, and other system resources available to virtual machines 332.

Each virtual machine 332 may include virtual disk 326A-C (generally 326) and virtual processor 328A-C (generally 328.) Virtual disk 326 may be a virtualized view of one or more physical disks 304 of virtualization server 301, or a portion of one or more physical disks 304 of virtualization server 301. The virtualized view of physical disks 304 may be generated, provided, and managed by hypervisor 302. In some embodiments, hypervisor 302 may provide each virtual machine 332 with a unique view of physical disks 304. These particular virtual disk 326 (included in each virtual machine 332) may be unique, when compared with other virtual disks 326.

Virtual processor 328 may be a virtualized view of one or more physical processors 308 of virtualization server 301. The virtualized view of physical processors 308 may be generated, provided, and managed by hypervisor 302. Virtual processor 328 may have substantially all of the same characteristics of at least one physical processor 308. Virtual processor 308 may provide a modified view of physical processors 308 such that at least some of the characteristics of virtual processor 328 are different from the characteristics of the corresponding physical processor 308.

FIG. 3A depicts a network diagram illustrating an example of a network environment 101, that can enable determination of virtual resource utilization. Determining utilization of a virtual resource can include logging transactions (e.g., API calls) by software services to the cloud that hosts the virtual resources, then assessing the logs to determine utilization of those virtual resources contained within the cloud. By logging transactions and then determining utilization based on the logs, an accurate determination of usage can be achieved. Referring to FIG. 3A, the network environment 101 in which various aspects of the disclosure can be implemented can include one or more clients 102a-102n, one or more remote machines 106a-106n, one or more networks 104a and 104b, and one or more appliances 108 installed within the network environment 101. The clients 102a-102n communicate with the remote machines 106a-106n via the networks 104a and 104b.

The clients 102a-102n can communicate with the remote machines 106a-106n via an appliance 108. The illustrated appliance 108 is positioned between the networks 104a and 104b, and can also be referred to as a network interface or gateway. The appliance 108 can operate as an application delivery controller (ADC) to provide clients with access to business applications and other data deployed in a datacenter, the cloud, or delivered as Software as a Service (SaaS) across a range of client devices, and/or provide other functionality such as load balancing and/or the like. Multiple appliances 108 can be used, and the appliance(s) 108 can be deployed as part of the network 104a and/or 104b.

The clients 102a-102n can be generally referred to as client machines, local machines, clients, client nodes, client computers, client devices, computing devices, endpoints, or endpoint nodes. The remote machines 106a-106n can be generally referred to as servers or a server farm. The client 102 can have the capacity to function as both a client node seeking access to resources provided by a server 106 and as a server 106 providing access to hosted resources for other clients 102a-102n. The networks 104a and 104b can be generally referred to as a network 104. The network 104 including the networks 104a and 104b can be configured in any combination of wired and wireless networks.

The servers 106 can include any server type of servers including, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 106 can execute, operate or otherwise provide an application that can be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft internet protocol telephone; an application for streaming video and/or audio; an application for facilitating real-time-data communications; a hypertext transfer protocol (HTTP) client; a file transfer protocol (FTP) client; an Oscar client; a Telnet client; or any other set of executable instructions.

The server 106 can execute a remote presentation services program or other program that uses a thin-client or a remote-display protocol to capture display output generated by an application executing on a server 106 and transmit the application display output to a client 102.

The server 106 can execute a virtual machine providing, to a user of a client 102, access to a computing environment. The client 102 can be a virtual machine. The virtual machine can be managed by, for example, a hypervisor, a virtual machine manager (VMM), or any other hardware virtualization technique within the server 106. The virtual machine can be deployed within a cloud provider.

The network 104a, 104b can be a local-area network (LAN), a metropolitan area network (MAN), a wide area network (WAN), a primary public network, and/or a primary private network. Additional embodiments can include one or more mobile telephone networks that use various protocols to communicate among mobile devices. For short-range communications within a wireless local-area network (WLAN), the protocols can include 802.11, Bluetooth, and Near Field Communication (NFC).

FIG. 3B depicts a block diagram illustrating an example of a computing device 300, in accordance with some example embodiments. Referring to FIGS. 3A-B, the computing device 300 can be useful for practicing an embodiment of the clients 102, the servers 106, and/or the appliances 108.

As shown in FIG. 3B, the computing device 300 can include one or more processors 248, volatile memory 270 (e.g., RAM), non-volatile memory 252 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 254, one or more communications interfaces 256, and a communication bus 258. The user interface 254 can include a graphical user interface (GUI) 260 (e.g., a touchscreen, a display, and/or the like) and one or more input/output (I/O) devices 262 (e.g., a mouse, a keyboard, and/or the like). In some implementations, the one or more input/output devices 262 can include a front facing camera. The non-volatile memory 252 can store an operating system 264, one or more applications 266, and data 268 such that computer instructions of the operating system 264 and/or applications 266 are executed by the processor(s) 248 out of the volatile memory 270. Data can be entered using an input device of the GUI 260 or received from I/O device(s) 262. Various elements of the computing device 300 can communicate via communication the bus 258. The computing device 300 as shown in FIG. 3B is shown merely as an example, as the clients 102, the servers 106, and the appliances 108 can be implemented by any computing or processing environment and with any type of machine or set of machines that can have suitable hardware and/or software capable of operating as described herein.

The processor(s) 248 can be implemented by one or more programmable processors executing one or more computer programs to perform the functions of the system. As used herein, the term “processor” describes an electronic circuit that performs a function, an operation, or a sequence of operations. The function, operation, or sequence of operations can be hard coded into the electronic circuit or soft coded by way of instructions held in a memory device. A “processor” can perform the function, operation, or sequence of operations using digital values or using analog signals. In some example embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” can be analog, digital or mixed-signal. In some example embodiments, the “processor” can be one or more physical processors or one or more “virtual” (e.g., remotely located or “cloud”) processors.

The communications interfaces 256 can include one or more interfaces to enable the computing device 300 to access a computer network such as a local area network (LAN), a wide area network (WAN), a public land mobile network (PLMN), and/or the Internet through a variety of wired and/or wireless or cellular connections.

As noted above, in some example embodiments, one or more computing devices 300 can execute an application on behalf of a user of a client computing device (e.g., the clients 102), can execute a virtual machine, which provides an execution session within which applications execute on behalf of a user or a client computing device (e.g., the clients 102), such as a hosted desktop session, can execute a terminal services session to provide a hosted desktop environment, or can provide access to a computing environment including one or more of: one or more applications, one or more desktop applications, and one or more desktop sessions in which one or more applications can execute.

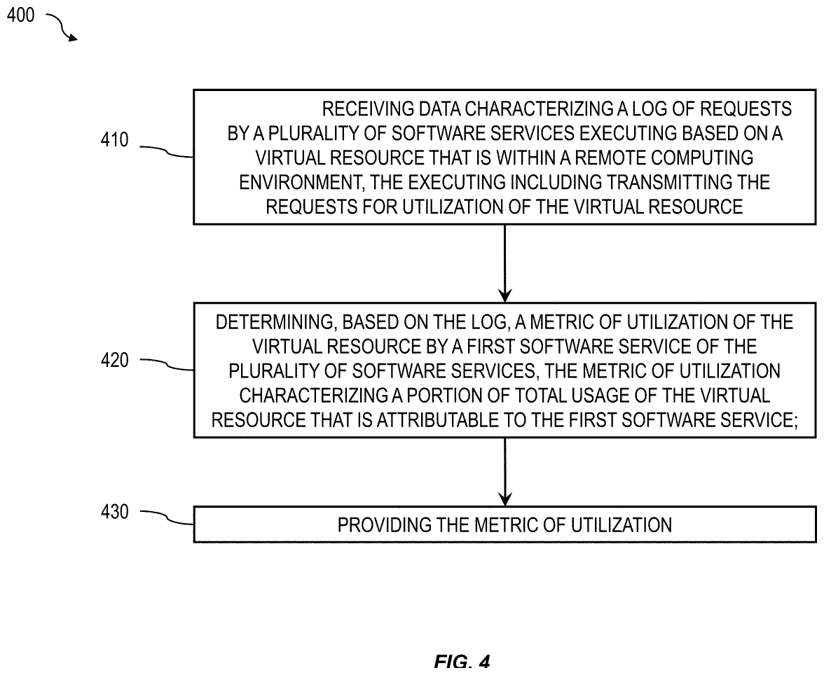

FIG. 4 is a process flow diagram illustrating another example process 400 that can enable determination of virtual resource utilization. Determining utilization of a virtual resource can include logging transactions (e.g., API calls) by software services to the cloud that hosts the virtual resources, then assessing the logs to determine utilization of those virtual resources contained within the cloud. By logging transactions and then determining utilization based on the logs, an accurate determination of usage can be achieved.

At 410, data is received characterizing a log of requests by software services executing based on a virtual resource that is within a remote computing environment (e.g., a cloud). The software service execution includes transmitting the requests for utilization of the virtual resource. The requests can include application programming interface calls to the remote computing environment. The software service can include or be a microservice.

The log can include a service name, a uniform resource identifier, a name of a consumer of a service, and a duration of use. Other information can be included in the log.

At 420, a metric of utilization of the virtual resource by a first software service of the plurality of software services can be determined based on the log. The metric of utilization can characterize a portion of total usage of the virtual resource that is attributable to the first software service. In some implementations, the metric of utilization is a percent of resource utilized by the first software service. For example, the metric of utilization can be a percent determined based on a number of request by respective software services, an amount of time the virtual resource is utilized by the respective software services, geographic region of the respective software services, and/or a type of application programming interface calls to the virtual resource made by the respective software services.

At 430, the metric of utilization can be provided. In some implementations, the providing includes modifying usage of the virtual resource by at least one of the plurality of software services. The providing can include further processing. For example, in some implementations, data characterizing a cost of the virtual resource can be accessed from the remote computing environment (e.g., cloud provider). A portion of the cost of the virtual resource attributable to the first software service can be determined based on the utilization metric and the cost of the virtual resource. In some implementations, respective portions of the cost of the virtual resource attributable to respective software services of the plurality of software services can be determined for multiple software services and based on the utilization metric. A cost of the virtual resource attributable to a product, a feature of the product, and/or a service of the product can be determined based on the utilization metric.

In some implementations, the process (e.g., the receiving, the determining, and the providing) can be repeated using a new log. The process can be repeated regularly, such as periodically, or after a predetermined event, such as a change to a product or service.

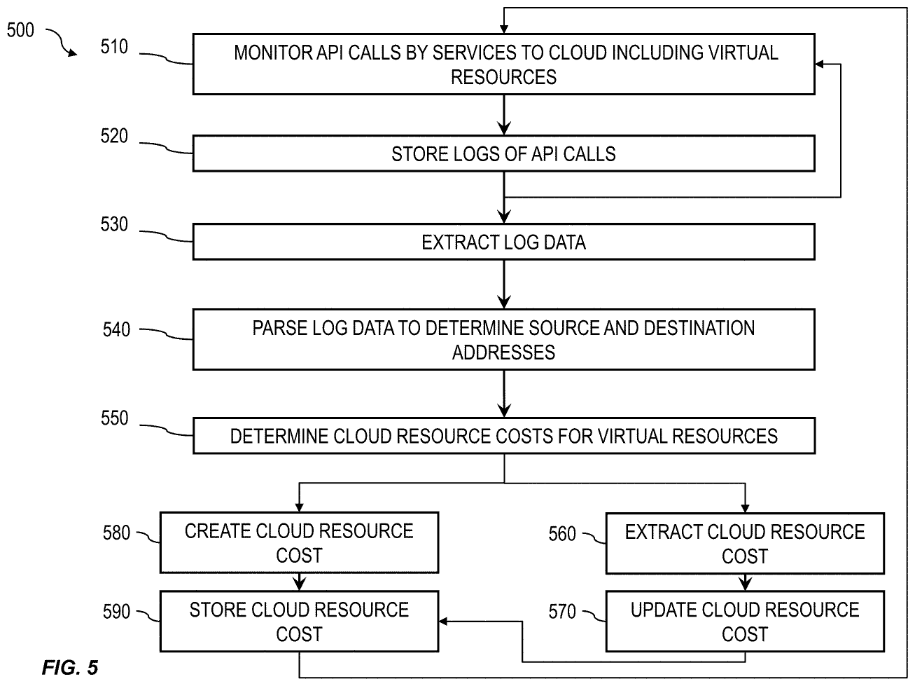

FIG. 5 is another process flow diagram illustrating an example process 500 that can enable determination of virtual resource utilization. Determining utilization of a virtual resource can include logging transactions (e.g., API calls) by software services to the cloud that hosts the virtual resources, then assessing the logs to determine utilization of those virtual resources contained within the cloud. By logging transactions and then determining utilization based on the logs, an accurate determination of usage can be achieved.

At 510, API calls by services to a cloud (e.g., remote computing environment) including virtual resources are monitored. The monitoring can include writing or creating a log entry every time a service performs an API call to the cloud. The log entry can include the source address, which includes the IP address of the service making the API call, and the destination address, which includes the IP address of the virtual resource that is utilized in performing the API call. Other information can be included in the log entry such as a type of API call; an amount of processing request by the API call; a name of the service and/or product making the API call; a uniform resource identifier; a name of a consumer of a service; a duration of use; and the like.

At 520, the log entries that are written and/or created during the monitoring of the API calls can be stored into a database. Once storage of the log entries is complete, the process 500 can return to monitoring the API calls at 510. Regularly (e.g., periodically) or at other times, the process can, at 530, extract the log data from the database. In some implementations, the log data that is extracted from the database can be a subset of all log data. The subset can be determined according to some criterion, such as being limited to those logs that were created or added to the database since the last time a resource utilization report or a cost of services report was last updated.

At 540, the log data is parsed to determine the metric of utilization for each virtual resource. At 550, a cloud resource cost for each virtual resource can be determined. Determining the cloud resource cost can include requesting updated cost information from the cloud providers and applying the resource costs to the metric of utilization to determine, for each service, a portion of a resource cost that is attributable to that service. Determining the cloud resource cost can include determining whether, for each service included in the log data, there is an existing cost of service report. If there exists a cost of service report, then at 560, the report can be extracted from a database and, at 570, the report can be updated with the newly determined cloud resource cost. The updated cloud resource cost can be stored at 590, for example, as a new cost of service report.

If there is no existing cost of service report, then at 580, a new cost of service report can be created. At 590, the new cost of service report can be stored. The process 500 can then return to monitoring the API calls at 510. In some implementations, monitoring the API calls at 510 is performed continuously and/or in parallel with the rest of the process 500.

Some implementations of the current subject matter can provide for many technical advantages. For example, in addition to cost, utilization can be tracked. In implementations where the logs specify usage, available metrics such as CPU utilization could provide insights into the scaling and performance of the service. And pairing log data with orders or entitlements per product, enables forecasting of costs of cloud spend and scaling factor to determine when more cloud resources are needed if and when more customers are added.

One or more aspects or features of the subject matter described herein can be realized in digital electronic circuitry, integrated circuitry, specially designed application-specific integrated circuit (ASIC), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. For example, the logic flows may include different and/or additional operations than shown without departing from the scope of the present disclosure. One or more operations of the logic flows may be repeated and/or omitted without departing from the scope of the present disclosure. Other implementations may be within the scope of the following claims.

What is claimed is:

1. A method comprising:
receiving data characterizing a log of requests by a plurality of software services executing based on a virtual resource that is within a remote computing environment, the executing including transmitting the requests for utilization of the virtual resource;
determining, based on the log, a metric of utilization of the virtual resource by a first software service of the plurality of software services, the metric of utilization characterizing a portion of total usage of the virtual resource that is attributable to the first software service; and
providing the metric of utilization.

2. The method of claim 1, wherein the metric of utilization is a percent of resource utilized the first software service.

3. The method of claim 1, wherein the metric of utilization is a percent determined based on
a number of requests by respective software services,
an amount of time the virtual resource is utilized by the respective software services,
geographic region of the respective software services, and/or
a type of application programming interface calls to the virtual resource made by the respective software services.

4. The method of claim 1, further comprising:
accessing, from the remote computing environment, data characterizing a cost of the virtual resource; and
determining, based on the utilization metric and the cost of the virtual resource, a portion of the cost of the virtual resource attributable to the first software service.

5. The method of claim 4, further comprising:
determining, for the plurality of software services and based on the utilization metric, respective portions of the cost of the virtual resource attributable to respective software services of the plurality of software services.

6. The method of claim 5, further comprising:
determining, based on the utilization metric, a cost of the virtual resource attributable to a product, a feature of the product, and/or a service of the product.

7. The method of claim 1, wherein the data characterizing the log includes a service name, a uniform resource identifier, a name of a consumer of a service, and a duration of use.

8. The method of claim 1, wherein the providing includes modifying usage of the virtual resource by at least one of the plurality of software services.

9. The method of claim 1, wherein the requests include application programming interface calls to the remote computing environment.

10. The method of claim 1, wherein the virtual resource includes a virtual machine, a storage account, a web application, a database, and/or a virtual network.

11. The method of claim 1, wherein the first software service includes executable code deployed in the remote computing environment.

12. The method of claim 11, wherein the first software service is a microservice.

13. A system comprising:
at least one data processor; and
memory storing instructions, which when executed by the at least one data processor causes the at least one data processor to perform operations comprising:
receiving data characterizing a log of requests by a plurality of software services executing based on a virtual resource that is within a remote computing environment, the executing including transmitting the requests for utilization of the virtual resource;
determining, based on the log, a metric of utilization of the virtual resource by a first software service of the plurality of software services, the metric of utilization characterizing a portion of total usage of the virtual resource that is attributable to the first software service; and
providing the metric of utilization.

14. The system of claim 13, wherein the metric of utilization is a percent of resource utilized the first software service.

15. The system of claim 13, wherein the metric of utilization is a percent determined based on
a number of request by respective software services,
an amount of time the virtual resource is utilized by the respective software services,
geographic region of the respective software services, and/or
a type of application programming interface calls to the virtual resource made by the respective software services.

16. The system of claim 13, the operations further comprising:
accessing, from the remote computing environment, data characterizing a cost of the virtual resource; and
determining, based on the utilization metric and the cost of the virtual resource, a portion of the cost of the virtual resource attributable to the first software service.

17. The system of claim 16, the operations further comprising:
determining, for the plurality of software services and based on the utilization metric, respective portions of the cost of the virtual resource attributable to respective software services of the plurality of software services.

18. The system of claim 17, the operations further comprising:
determining, based on the utilization metric, a cost of the virtual resource attributable to a product, a feature of the product, and/or a service of the product.

19. The system of claim 13, wherein the data characterizing the log includes a service name, a uniform resource identifier, a name of a consumer of a service, and a duration of use.

20. A non-transitory computer readable medium storing instructions which, when executed by at least one data processor forming part of at least one computing system, causes the at least one data processor to perform operations comprising:
receiving data characterizing a log of requests by a plurality of software services executing based on a virtual resource that is within a remote computing environment, the executing including transmitting the requests for utilization of the virtual resource;
determining, based on the log, a metric of utilization of the virtual resource by a first software service of the plurality of software services, the metric of utilization characterizing a portion of total usage of the virtual resource that is attributable to the first software service; and
providing the metric of utilization.
